(19) United States
(12) Patent Application Publication
(10) Pub. No.: US 2007/0027670 A1
(43) Pub. Date: Feb. 1, 2007

(54) User Interface Update System

(75) Inventors: Ryan J. Verhey-Henke, Ann Arbor, MI (US); Joseph David Purcell, Ann Arbor, MI (US); Perumal Sivakumar, Valencia, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS HEALTH SERVICES CORPORATION, Malvern, PA (US)

(21) Appl. No.: 11/419,334

(22) Filed: May 19, 2006

Related U.S. Application Data
(60) Provisional application No. 60/698,688, filed on Jul. 13, 2005.

(51) Int. Cl. G06F 17/28

(52) U.S. Cl. 704/2

(57) ABSTRACT

A system uses a readable structured (e.g., XML) file format that contains user interface display image text strings to streamline the translation process of user interface strings in a software application and that facilitates creation of a readable XML document. A system processes user interface image text strings to support text string translation into text of different spoken languages. The system includes an input processor for parsing a source document supporting generation of a user interface image to identify text in a first language for translation to a different second language. A processor generates a first structured file incorporating the identified text strings together with associated information facilitating accurate translation of the identified text strings and indicating replicated text strings. An output processor processes the generated first structured file to be suitable for subsequent translation.

This is a non-provisional application of provisional application Ser. No. 60/698,688 by Ryan J. Verhey-Henke et al. filed Jul. 13, 2005.

### FIELD OF THE INVENTION

This invention concerns a system for processing user interface image text strings to support text string translation into text of different spoken languages, facilitating accurate translation of text strings and generation of user interface images in different languages.

### BACKGROUND OF THE INVENTION

In existing systems, resource dynamic link library elements (dlls) or text files are used to define and retrieve User Interface (UI) text strings. This presents problems during a language translation process in which UI text strings appearing in an image display in one language (e.g., English) need to be translated into a different spoken language (e.g., Chinese) in another image display. Localized language components typically employ libraries of dll files that support dialogs, windows, tooltips, and balloon text of user interface image elements in different languages as well as English, for example. In order to generate resource dlls, compilation of code is required. This means when a UI text string is modified or added to a UI display image, the code needs to be re-compiled in order to generate the newest dll version in a different spoken language. The newest dll version is typically communicated to a spoken language translation company for translation. The translation company processes both previously translated strings, albeit at a lower cost, as well as modified or added strings. This increases unnecessarily increasing translation costs. In addition, when code is recompiled, testing of the application is performed, which in turn increases development costs.

Text files, when used as a UI string resource, present several problems. First, since the format of the text file is typically at the discretion of a developer that accesses and parses the file, these files are not uniform in nature. Also, these files tend to lack detailed contextual comments in order to ease and improve performance of the parsing process. The preceding issues both can increase spoken language translation cost and error substantially. A translation company needs to customize tools for individual text files and the lack of detailed contextual comment necessitates inquiries by translators for clarification of UI image text string usage. Also, problems introduced in text files are often difficult to debug since their formatting is easily disturbed (e.g., inadvertent deletion of a necessary delimiter by translators resulting in incorrect parsing of a file). This compounds the UI text string language conversion difficulties. In addition to these difficulties with typically used string resource formats, multi-component applications tend to have several types of string resource files, which increases project management and logistical problems. A system according to invention principles addresses these deficiencies and related problems.

### SUMMARY OF THE INVENTION

A system uses a readable structured (e.g., XML) file format that contains UI display image text strings independent of a format of a source of the UI text string and that enables recreation of the source files from a translated version of a file without hindering file translation. A system processes user interface image text strings to support text string translation into text of different spoken languages. The system includes an input processor for parsing a source document supporting generation of a user interface image to identify text in a first language for translation to a different second language. A processor generates a first structured file incorporating the identified text strings together with associated information facilitating accurate translation of the identified text strings and indicating replicated text strings. An output processor processes the generated first structured file to be suitable for subsequent translation.

### BRIEF DESCRIPTION OF THE DRAWING

FIG. 1 shows a system for processing user interface image text strings to support text string translation into text of different spoken languages, according to invention principles.

FIG. 2 shows a process employed by a system for processing user interface image text strings, according to invention principles.

FIG. 3 shows a file format including text strings for translation, according to invention principles.

FIG. 4 shows a file structure created by a system for processing user interface image text strings, according to invention principles.

FIG. 5 shows a flowchart of a process used by an image format determination system, according to invention principles.

### DETAILED DESCRIPTION OF THE INVENTION

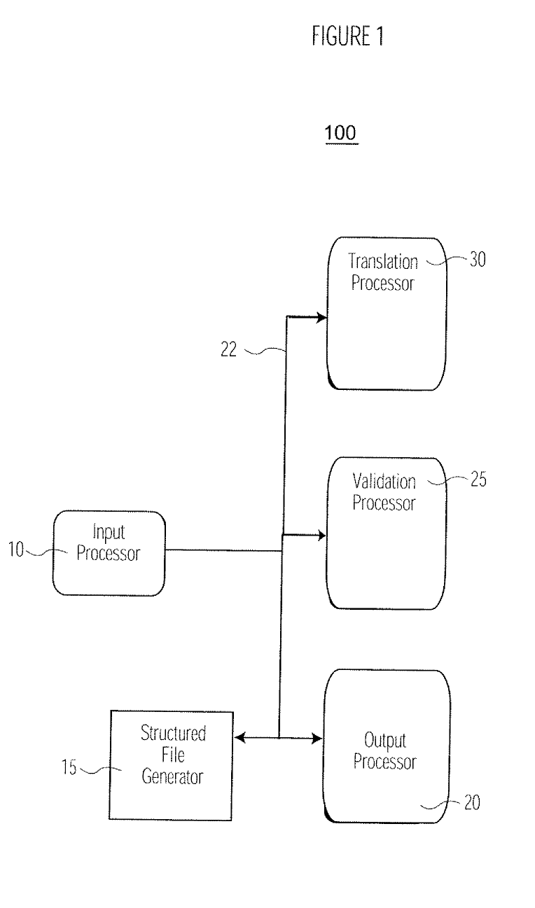

FIG. 1 shows system 100 for processing user interface image text strings to support text string translation into text of different spoken languages. System 100 and/or elements contained therein also may be implemented in a centralized or decentralized configuration. The system 100 may be implemented as a client-server, web-based, or stand-alone configuration. Elements of system 100 communicate via path 22 (otherwise called a network, bus, link, connection, channel, etc.) using any type of protocol or data format. The protocol or data format includes, but is not limited to, one or more of the following: an Internet Protocol (IP), a Transmission Control Protocol internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, a Campus Area Network (CAN) protocol, a Metropolitan Area Network (MAN) protocol, a Home Area Network (HAN) protocol, an Institute Of Electrical And Electronic Engineers (IEEE) bus compatible protocol, a Digital and Imaging Communications (DICOM) protocol, and a Health Level Seven (HL7) protocol.

An executable application as used herein comprises code or machine readable instruction for implementing predetermined functions including those of an operating system, healthcare information system or other information processing system, for example, in response user command or input. An executable procedure is a segment of code (machine readable instruction), sub-routine, or other distinct section of code or portion of an executable application for performing one or more particular processes and may include performing operations on received input parameters (or in response to received input parameters) and provide resulting output parameters. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating data representing display images or portions thereof. A user interface comprises one or more display images enabling user interaction with a processor or other device. A schema (also schema definition) is information indicating the organization or structure of an XML transaction.

Input processor 10 parses a source document supporting generation of a user interface image to identify text in a first spoken language for translation to a different second spoken language. Processor 15 generates a first structured file incorporating the identified text strings together with associated information facilitating accurate translation of the identified text strings and indicating replicated text strings. The associated information facilitating accurate translation of the identified text strings comprises information guiding how a text translation is to be done and includes one or more of, information indicating how a word is used, whether a word is used as a noun or verb and information indicating text is associated with a particular type of image element and describing the function of the image element. The associated information also includes at least one of, information indicating a text item is linked with another different text item, information explaining a text abbreviation and information indicating size of space available to accommodate a text item to be translated. A replicated text string is identified by an indicator indicating one or more of, a text string is replicated and a first instance of the replicated text string. The first file employs a well formatted markup language file format such as, an XML file format, an SGML file format and an HTML file format. Output processor 20 processes the generated first structured file to be suitable for subsequent translation.

Translation processor 30 receives a second structured file incorporating text strings translated into a second language corresponding to text strings in the first language in the first structured file. Translation processor 30 automatically replaces text strings in the first language in the source document with corresponding text strings in the second language in the second structured file. Validation processor 25 compares the received second structured file with the first structured file and generates a message indicating a discrepancy in response to the comparison. Validation processor 25 compares the received second structured file with the first structured file by verifying, (a) a text string in the first structured file has a corresponding text string in the second structured file and (b) text strings in the second structured file are translated into the second language.

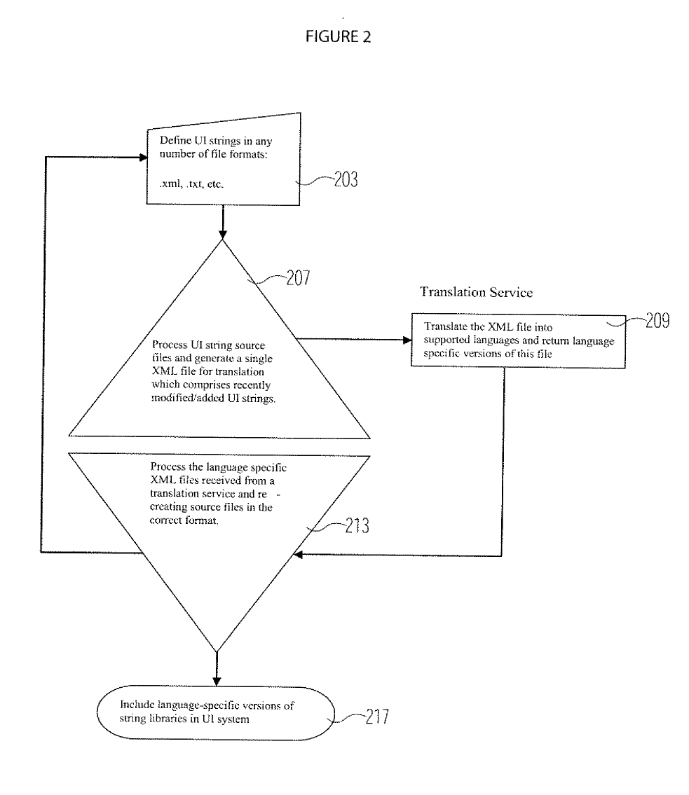

FIG. 2 shows a process employed by system 100, operating in conjunction with a translation system, for processing user interface image text strings. The user interface image text strings are individually associated with elements (components) displayed in a user interface image, i.e., the user interface image text strings are component specific and comprise, for example, any text used in dialogs, windows, toolbars, information bars, tooltips, and balloon text of user interface image elements in different languages as well as English, for example. System 100 in step 203 provides text strings in a number of different data structure formats including component specific (or non-component specific in another embodiment) XML file format, txt file format, SGML file format and an HTML file format, for example. In step 207, system 100 processes the text strings in the different data structure file formats and generates a single XML compatible file for language translation. The single XML compatible file contains recently modified and added user interface text strings and is created by automatically merging user interface text strings associated with software elements into a single XML file. In another embodiment, the user interface text strings are merged into a single XML file manually. System 100 communicates the single XML compatible file to a translation service (manual or automatic translation) for processing. In step 209, the translation service translates the single XML compatible file into multiple supported spoken languages and communicates language specific versions of the single XML compatible file to system 100. System 100 in step 213 receives and processes a version of the XML compatible file for each supported spoken language and re-creates corresponding language specific source files in the correct format (e.g., corresponding XML, txt, SGML or HTML file format as employed in step 203). In step 217, system. 100 provides language specific text strings derived from the re-created language specific source files to provide language specific string libraries (with an associated version identifier) for use in user interface display images.

In the FIG. 2 process, in response to text string modification or addition, system 100 repeats steps 203 and 207 to merge modified or added component specific user interface text string resource files (xml, txt, files etc.) to regenerate a single XML compatible file for language translation for each additional round of translation. Further, in step 207, system 100 advantageously compares the regenerated single XML compatible file with the previously generated single XML compatible file and generates a new single XML compatible file that contains the differences between the two previously generated single XML compatible files (UI text string master files). System 100 communicates the single XML compatible file containing the differences between the two previously generated single XML compatible files to the translation service (manual or automatic translation) for processing. In step 209, the translation service translates the single XML compatible file into multiple supported spoken languages and communicates to system 100 individual language specific versions of the single XML file containing the differences for individual supported spoken languages. System 100 in step 213 receives and processes individual language specific versions of the single XML file containing the differences (one version of the XML difference file for each spoken language). System 100 merges the difference containing XML files into the master XML file (the non-difference containing XML master file previously received in step 213 from the translation service) for each supported language. System 100 re-generates component specific user interface text string resource files by re-creating corresponding language specific source files in the correct format (e.g., corresponding to the XML, txt, SGML or HTML file format as employed in step 203). In step 217, system 100 provides language specific text strings derived from the re-created language specific source files to provide language specific string libraries (with an associated version identifier) for use in user interface display images.

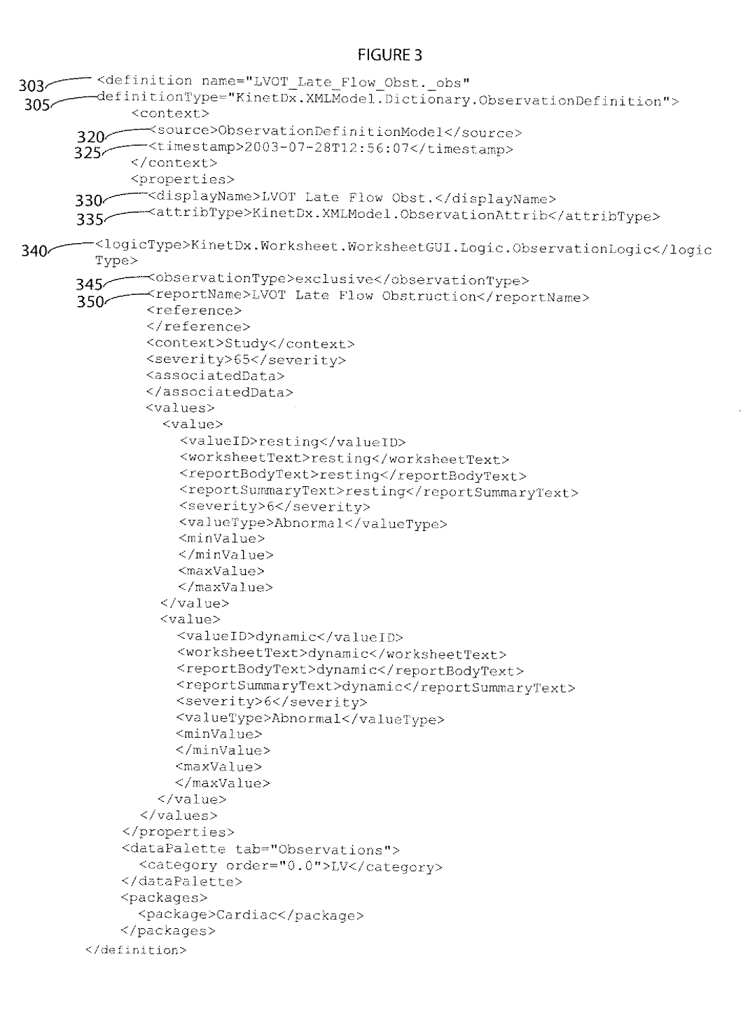

In operation of one embodiment, system 100 processes a variety of user interface text string source files (in various formats) and imports text strings into XML. In addition to the strings designated for translation, system 100 adds nodes describing text string associated image element usage context and meaning of the English strings to facilitate translation, as well as information concerning the source from which the string came. FIG. 3 illustrates a file format including text strings for translation. Items 303 and 305 indicate a user interface image element item definition name and definition type respectively and items 320 and 325 show associated context information. Further associated properties are also shown including displayed name 330, attribute type 335, logic type 340, observation type 345 and a name used in a report 350. System 100 automatically parses this file and acquires and processes the user interface text strings derived from this file to create an XML file to be translated that facilitates translation.

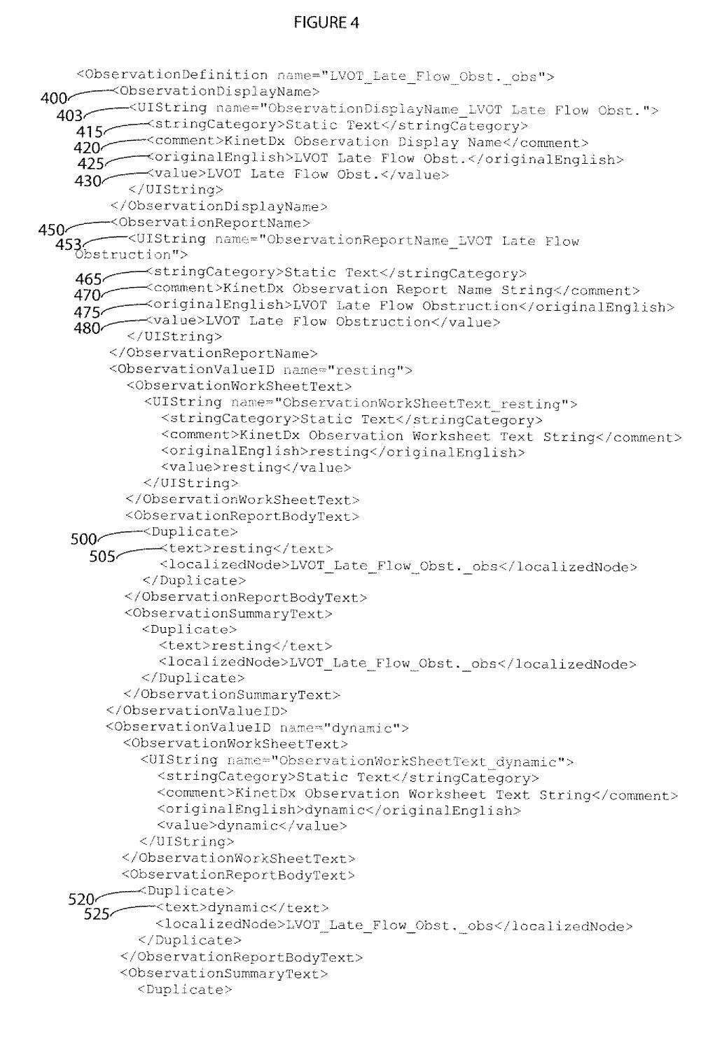

FIG. 4 shows a file structure created by system 100 by automatically processing user interface image text strings in the file of FIG. 3 using a process described in connection with FIG. 2. System 100 parses the language statements of the FIG. 3 file format using predetermined language specific terms, syntax, labels and identifiers to identify user interface text strings to be translated as well as context information associated with a text string and corresponding image element. For example, system 100 looks for items including definition name, definitionType, context, displayname, properties and attribType and their associated data field items. Identified items are recognized as user interface strings and associated context information and the identified items are incorporated in user interface text string statement fields and associated context fields in an XML structure as exemplified in FIG. 4. The file structure of FIG. 4 contains information regarding location of a store of a source user interface text string, in addition to the text string to be translated. Items 400 and 403 indicate a user interface element name (ObservationDisplayName) and an associated user interface text string name (ObservationDisplayName_LVOT Late Flow Obst.), respectively. Items 415, 420, 425 and 430 indicate associated context information facilitating translation. Item 415 indicates a user interface text string category (here static), item 420 is a comment concerning the user interface text string, item 425 indicates original English language corresponding to the user interface text string and item 430 indicates a value of the user interface text string

Similarly, items 450 and 453 indicate a user interface element name (ObservationReportName) and an associated user interface text string name (ObservationReportName_LVOT Late Flow Obstruction), respectively. Items 465, to 470, 475 and 480 indicate associated context information facilitating translation. Item 465 indicates a user interface text string category (here static), item 470 is a comment concerning the user interface text string, item 475 indicates original English language corresponding to the user interface text string and item 480 indicates a value of the user interface text string.

In addition, system 100 advantageously reduces processing and interfacing burden as well as error and data corruption, by incorporating indicators identifying duplicate text strings in the XML file to be communicated to a translation service. In FIG. 4, duplicate “resting” (items 500 and 505) user interface text strings and “dynamic” (items 520 and 525) user interface text strings are identified as duplicates, for example. System 100 links an individual string to its first instance (e.g., by using a duplicate indicator) and omits a text string value element, to obtain an accurate translation for the text strings without redundant processing and translation. The system takes advantage of existing translation technology that readily translates text strings between begin and end tags of value elements (e.g. row 430).

System 100 advantageously addresses the previously identified problems of existing systems by using XML (or another markup language) as a user interface text string definition medium to facilitate parsing with available text data processors (e.g., such as those used in Word, Excel etc.) thereby eliminating the need for creation of customized parsing processors. A markup language combines text and extra information about the text. The extra information concerns the text structure or presentation, for example and is expressed using markup, which is intermingled with the primary text. System 100 validates file format by comparing it with a predetermined schema to prevent accidental modifications of the file structure. The system further advantageously automatically provides detailed contextual comments concerning an individual user interface text string throughout the created XML file provided to a translation service along with other pieces of information to aid text string translation. The contextual comments provide user interface image text string usage information indicating, for example, the function, purpose and method of operation of a user interface image element and a description of how the user interface image element is employed.

In one embodiment, system 100 communicates a single XML (for example) file to a translation service thereby reducing logistical problems and project management burden involved in providing a user interface. In update of a user interface involving additional and modified user interface text strings, a single XML difference file is communicated to the translation service for translation. The single XML difference file includes differences between a first master XML file last communicated to a translation service for translation and a subsequent version second master XML file comprising a current and updated version of the first master XML file, for example. This reduces the data processing burden and processing error and improves data processing and interfacing speed by reducing, compilation, input-output interfacing and communication of redundant and previously translated text strings for translation as well as in duplicative redundant processing of re-translated replicated text strings and text string portions. System 100 further reduces the cost of user interface image text string translation by reducing the re-processing and re-translation of text strings contained in a text string file previously communicated to a translation service for translation. System 100 also reduces text string translation turn-around time because a smaller XML difference file is being processed. The translated user interface text string data is used by Medical Personnel, such as doctors, sonographers and radiologists for example.

System 100 provides, a robust method of translating user interface text strings involving validation of an XML file against a schema to identify corrupt files and errors and providing flexibility through use and manipulation of XML files. The system facilitates development of executable applications and procedures for manipulation of user interface text string files to produce a master user interface text string definition XML file as well as in the pre-processing and post-processing involved in generating the XML files involved in the process of FIG. 2. The XML files generated also include detailed contextual comments concerning user interface image elements associated with text strings facilitating text string translation.

In contrast, existing systems typically communicate a number of string resource files (dlls, text files) to a translation service for translation rather than one XML file and are error prone and subject to accidental modification of file formats. Further, existing systems communicate text strings already previously translated to a translation service for redundant translation due to the fact the text strings are compiled into dlls.

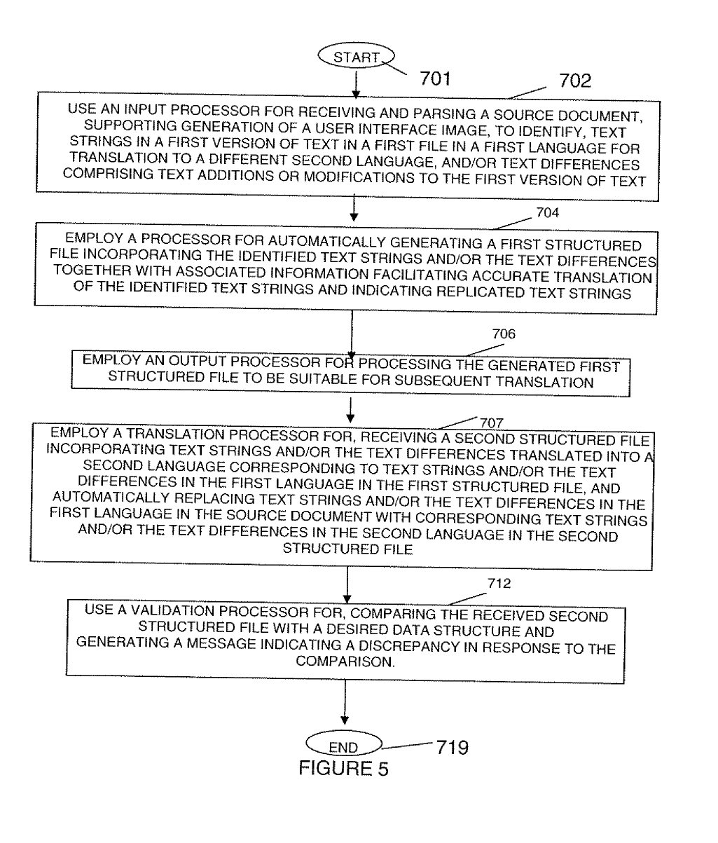

FIG. 5 shows a flowchart of a process used by an image format determination system (system 100 of FIG. 1). In step 702 following the start at step supporting generation of a user interface image, to identify text strings in a first version of text in a first file in a first language for translation to a different second language and/or text differences comprising text additions or modifications to the first version of text in the first file in the first language for translation to the different second language. The input processor identifies, the identified text strings and/or text differences or the context information associated with the identified text strings or differences, using predetermined language specific terms. In step 704, processor 15 automatically generates a first structured file incorporating the identified text strings and/or text differences together with associated information facilitating accurate translation of the identified text strings and/or text differences and indicating replicated text strings and/or text differences. The first file employs a well formatted markup language file format such as, an XML file format, an SGML file format and an HTML file format.

The associated information facilitating accurate translation of the identified text strings and/or text differences comprises information guiding how a text translation is to be done and includes at least one of, information indicating how a word is used, whether a word is used as a noun or verb and information indicating text is associated with a particular type of image element and describing the function of the image element. The associated information facilitating accurate translation of the identified text strings and/or text differences also comprises one or more of, information indicating a text item is linked with another different text item, information explaining a text abbreviation and information indicating size of space available to accommodate a text item to be translated. A replicated text string is identified by an indicator indicating at least one of, a text string is replicated and a first instance of the replicated text string. In step 706, output processor 20 processes the generated first structured file to be suitable for subsequent translation.

Translation processor 30 in step 707 receives a second structured file incorporating text strings and/or text differences translated into a second language corresponding to text strings and/or text differences in the first language in the first structured file. Translation processor 30 automatically replaces text strings and/or text differences in the first language in the source document with corresponding text strings and/or text differences in the second language in the second structured file. Validation processor 25 in step 712 compares the received second structured file with a desired data structure and generates a message indicating a discrepancy in response to the comparison. Validation processor 25 compares the received second structured file with the desired data structure by verifying, a text string in the first structured file has a corresponding text string in the second structured file and text strings in the second structured file are translated into the second language. The process of FIG. 5 ends at step 719.

The systems and processes presented in FIGS. 1-5 are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. A system according to to invention principles is usable for processing user interface image text strings to support text string translation into text of different spoken languages. Further, any of the functions provided by the systems and processes of FIGS. 1-5 may be implemented in hardware, software or a combination of both and may reside on one or more processing devices located at any location of a network linking the FIG. 1 elements. The system uses a structured (e.g., XML) file format to streamline the translation process of user interface text strings in a software application, for example. The system facilitates creation of a readable XML document that contains executable application user interface strings irrespective of the format of the source of the user interface string. The XML file contains the information needed to recreate the source files from the translated version of the file received from a translation service without hindering the translation process.

What is claimed is:

1. A system for processing user interface image text strings to support text string translation into text of different spoken languages, comprising:
an input processor for parsing a source document supporting generation of a user interface image to identify text strings in a first language for translation to a different second language;
a processor for generating a first structured file incorporating said identified text strings together with associated information facilitating accurate translation of said identified text strings and indicating replicated text strings; and
an output processor for processing said generated first structured file to be suitable for subsequent translation.

2. A system according to claim 1, including
a translation processor for,
receiving a second structured file incorporating text strings translated into a second language corresponding to text strings in said first language in said first structured file and
automatically replacing text strings in said first language in said source document with corresponding text strings in said second language in said second structured file.

3. A system according to claim 2, including
a validation processor for,
comparing said received second structured file with a desired data structure and
generating a message indicating a discrepancy in response to said comparison.

4. A system according to claim 3, wherein
said validation processor compares said received second structured file with said desired data structure by verifying,
(a) a text string in said first structured file has a corresponding text string in said second structured file and
(b) text strings in said second structured file are translated into said second language.

5. A system according to claim 1, wherein
said first structured file is in at least one of, (a) an XML file format, (b) an SGML file format and (c) an HTML file format.

6. A system according to claim 1, wherein
said associated information facilitating accurate translation of said identified text strings comprises information guiding how a text translation is to be done and including at least one of, (a) information indicating how a word is used, (b) whether a word is used as a noun or verb and (c) information indicating text is associated with a particular type of image element and describing the function of the image element.

7. A system according to claim 1, wherein
said associated information facilitating accurate translation of said identified text strings comprises information guiding how a text translation is to be done and including at least one of, (a) information indicating a text item is linked with another different text item, (b) information explaining a text abbreviation and (c) information indicating size of space available to accommodate a text item to be translated.

8. A system according to claim 1, wherein
a replicated text string is identified by an indicator indicating at least one of, (a) a text string is replicated and (b) a first instance of said replicated text string.

9. A system according to claim 1, wherein
said input processor identifies at least one of, (a) said identified text strings and (b) said context information associated with said identified text strings, using predetermined language specific terms.

10. A system for processing user interface image text strings to support text string translation into text of different spoken languages, comprising:
an input processor for receiving data representing text differences comprising text additions or modifications to a first version of text in a first file, said first version of text in said first file being in a first language and having been previously translated in to a different second language;
a processor for generating a first structured file incorporating said text differences with associated information facilitating accurate translation of said identified text differences; and
an output processor for processing said generated first structured file to be suitable for subsequent translation.

11. A system according to claim 10, including
said first structured file is an XML compatible file.

12. A system according to claim 10, including
said first structured file is at least one of, (a) an SGML compatible file and (b) an HTML compatible file.

13. A system according to claim 10, wherein
said first structured file indicates replicated text strings

14. A system according to claim 10, including
a translation processor for receiving a second structured file incorporating text differences translated into a second language corresponding to said text differences in said first language in said first structured file.

15. A system according to claim 14, wherein
said translation processor automatically replaces text differences in said first language in a file with said text differences translated into a second language.

16. A system according to claim 10, including
an input processor for parsing a source document supporting generation of a user interface image to identify said text differences.

17. A system for processing user interface image text strings to support text string translation into text of different spoken languages, comprising:
an input processor for parsing a source document supporting generation of a user interface image to identify text differences comprising text additions or modifications to a first version of text in a first file, said first version of text in said first file being in a first language and having been previously translated in to a different second language;
a processor for automatically generating a first structured file incorporating said text differences with associated information facilitating accurate translation of said identified text differences; and
an output processor for processing said generated first structured file to be suitable for subsequent translation.

18. A system according to claim 17, wherein
said first structured file indicates replicated text strings

19. A system according to claim 17, wherein
said input processor identifies at least one of, (a) said text differences and (b) said context information associated with said text differences, using predetermined language specific terms.

20. A system according to claim 16, wherein
said input processor identifies said text differences using predetermined language specific terms.
